(19) United States
(12) Patent Application Publication
(10) Pub. No.: US 2010/0325935 A1
(43) Pub. Date: Dec. 30, 2010

(54) Fishing tackle for stowage of fishing line

(75) Inventor: Wei-Hsiung Chen, Changhua (TW)

Correspondence Address: BACON & THOMAS, PLLC, 625 SLATERS LANE, FOURTH FLOOR, ALEXANDRIA, VA, 22314-1176, US

(73) Assignee: DONGSHAN OKEY METAL & PLASTIC PRODUCTS CO., LTD., FUJIAN (CN)

(21) Appl. No.: 12/458,055

(22) Filed: Jun. 30, 2009

(51) Int. Cl. A01K 97/00

(52) U.S. Cl. 43/25

(57) ABSTRACT

A fishing tackle for stowage of a fishing line is adapted to be mounted to a fishing rod. The fishing tackle includes a bracket having a holding portion for abutting against the fishing rod, a guide rod having a distal end fastened to the bracket, a spool around which the fishing line is windable and which is rotatably mounted to the guide rod, and a retainer pivotally connected to the bracket. The retainer has a retaining portion for pushing the fishing rod to be firmly urged against the holding portion of the bracket such that the fishing tackle can be mounted to the fishing rod by holding the fishing rod between the holding portion of the bracket and the retaining portion of the retainer.

### BACKGROUND OF THE INVENTION

1. Field of the Invention

The present invention relates generally to a fishing tackle for stowage of a fishing line, and more specifically to a fishing tackle that can be detachably mounted to a fishing rod for conveniently feeding a fishing line to a fishing reel of the fishing rod.

2. Description of the Related Art

A fishing line is generally wound around a rotatable cylinder in advance and then transferred onto a fishing reel of a fishing rod by means of the rotation of the cylinder. In angling, the fishing line may be snapped when a fishhook is hooked to a heavy object or an enormous fish. If the fishing line wound on the fishing reel is insufficient in length before angling, the residual fishing line will be probably not long enough for anglers to continue another run of angling after the fishing line is snapped, stopping the fishing activity.

There is a conventional fishing tackle for stowage of a fishing line to be supplied onto the fishing reel of the fishing rod, including a sucking disc to be attachable onto a wall or any other desired location. Although the aforesaid conventional fishing tackle is portable, it is found that finding a suitable location around the fishing environment for attachment of the aforesaid conventional fishing tackle is difficult, and furthermore the aforesaid conventional fishing tackle can not be firmly mounted on an object by means of the suction of the sucking disc. Therefore, it is a need to provide an improved fishing tackle for stowage of a fishing line.

### SUMMARY OF THE INVENTION

The present invention has been accomplished in view of the above-noted circumstances. It is one objective of the present invention to provide a fishing tackle for stowage of a fishing line, which can be detachably secured to a fishing rod for conveniently feeding a fishing line to a fishing reel of the fishing rod.

To achieve this objective of the present invention, the fishing tackle for stowage of a fishing line is adapted to be mounted to a fishing rod and comprises a bracket having a holding portion, a guide rod having a distal end fastened to the bracket, a spool rotatably mounted to the guide rod for winding of a fishing line thereupon, and a retainer pivotally connected to the bracket and having a retaining portion for pushing the fishing rod to be urged against the holding portion of the bracket.

By means of the aforesaid design, an angler can place a fishing rod on the holding portion of the bracket and clamp the fishing rod between the holding portion of the bracket and the retaining portion of the retainer through the pivotal movement of the retainer such that the fishing tackle of the present invention can be secured firmly to the fishing rod for enabling feeding of a fishing line to a fishing reel of the fishing rod at any time.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a perspective view of a fishing tackle according to a first preferred embodiment of the prevent invention;

FIG. 2 is an exploded view of the fishing tackle according to the first preferred embodiment of the prevent invention;

FIG. 3 is a perspective view of the fishing tackle according to an alternate structure of the first preferred embodiment of the prevent invention, in which the bracket has one holding portion;

FIG. 4 is a perspective view of the fishing tackle according to a second preferred embodiment of the prevent invention;

FIG. 5 is an end view of the fishing tackle according to the second preferred embodiment of the prevent invention, showing the fishing tackle is mounted with the fishing rod;

FIG. 6 is a perspective view of the fishing tackle according to a third preferred embodiment of the prevent invention, and

FIG. 7 is an end view of the fishing tackle according to the third preferred embodiment of the prevent invention, showing the fishing tackle is mounted with the fishing rod.

### DETAILED DESCRIPTION OF THE INVENTION

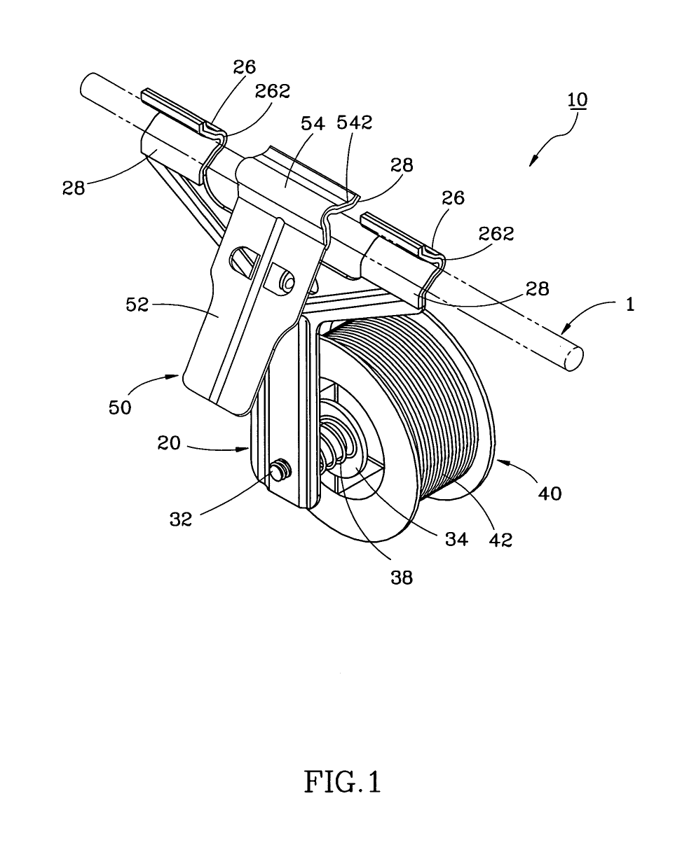

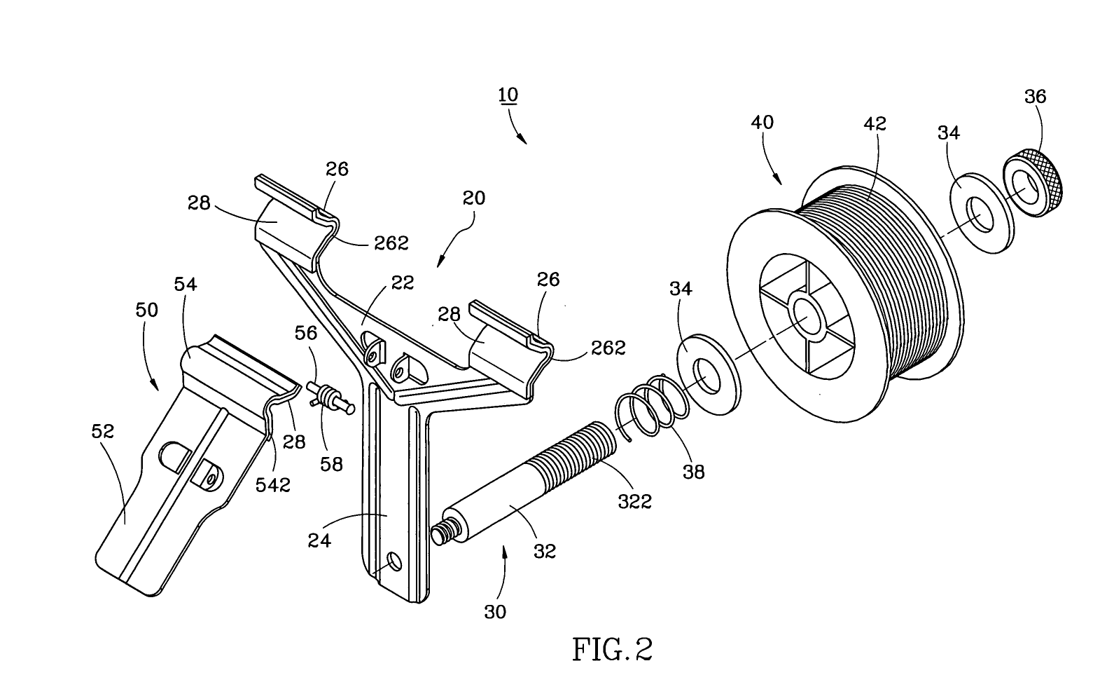

As shown in FIG. 1, a fishing tackle 10 for stowage of a fishing line 42 in accordance with a first preferred embodiment of the present invention is adapted to be mounted to a fishing rod 1 when it is in use. Referring to FIGS. 1-2, the fishing tackle 10 comprises a bracket 20, a guide unit 30, a spool 40, and a retainer 50.

The bracket 20 has an inverted-triangle head portion 22, a rectangular body portion 24 extending downwards from one vertex of the head portion 22, two holding portions 26 extending upwards from the other two vertexes of the head portion 22 and spaced from each other at a predetermined distance. The holding portions 26 each have a first V-shaped recess 262, and a protective pad 28 made of flexible materials and disposed in the first recess 262.

Referring to FIG. 2 again, the guide unit 30 includes a guide rod 32 having an end screwed to a bottom end of the body portion 24 of the bracket 20 and a threaded section 322, two washers 34 sleeved on the guide rod 32, a nut 36 threaded with the threaded section 322, and an elastic member 38 sleeved on the guide rod 32 and having two ends respectively stopped against the body portion 24 of the bracket 20 and one of the washers 34.

The spool 40 is rotatably sleeved onto the guide rod 32 of the guide unit 30 for winding of a fishing line 42 thereupon, and located between the washers 34 such that the spool 40 can be pushed by the elastic member 38 through one of the washers 34, such that the spool 40 is moveable along an axial direction of the guide rod 32.

The retainer 50 is embodied as a metal plate, having a press portion 52 and a retaining portion 54 integrally formed on a top end of the press portion 52 and provided with a second V-shaped recess 542 and a protective pad 28 disposed in the second recess 542. The press portion 52 of the retainer 50 is pivotally connected to one side of the head portion 22 of the bracket 20 through a pivot 56 and a torsion spring 58 sleeved onto the pivot 56, such that the retaining portion 54 is forced by the torsion spring 58 to pivotally move toward the holding portion 26 of the bracket 20 and eventually be located between the holding portion 26 of the bracket 20 at a normal condition.

To mount the fishing tackle 10 to the fishing rod 1, an angler can press the press portion 52 of the retainer 50 to force the retaining portion 54 of the retainer 50 to be pivotally moved away from the holding portions 26 of the bracket 20, and then place the fishing rod 1 between the holding portions 26 of the bracket 20 and the retaining portion 54 of the retainer 50. Thereafter, the angler can release the press portion 52 to enable the retaining portion 54 to pivotally move back so as to push the fishing rod 1 to be urged against the holding portions 26 of the bracket 20 through the pivotal movement of the retainer 50. As a result, the fishing tackle 10 of the present invention can be secured to the fishing rod 1 by periphery walls of the holding portions 26 of the bracket 20 and a periphery wall of the retaining portion 54 of the retainer 50. In light of this, when encountering a situation where a fishing line wound on a fishing reel (not shown) of a fishing rod 1 is insufficient in length, the angler can conveniently transfer the fishing line 42 from the spool 40 to the fishing reel of the fishing rod 1. Further, the protective pads 28 can prevent damage to the fishing rod 1 when the fishing rod 1 is clamped between the holding portions 26 of the bracket 20 and the retaining portion 54 of the retainer 50. Besides, the fishing line can be wound tightly on the fishing reel of the fishing rod 1 through the axial movement of the spool 40 caused by the elastic member 38.

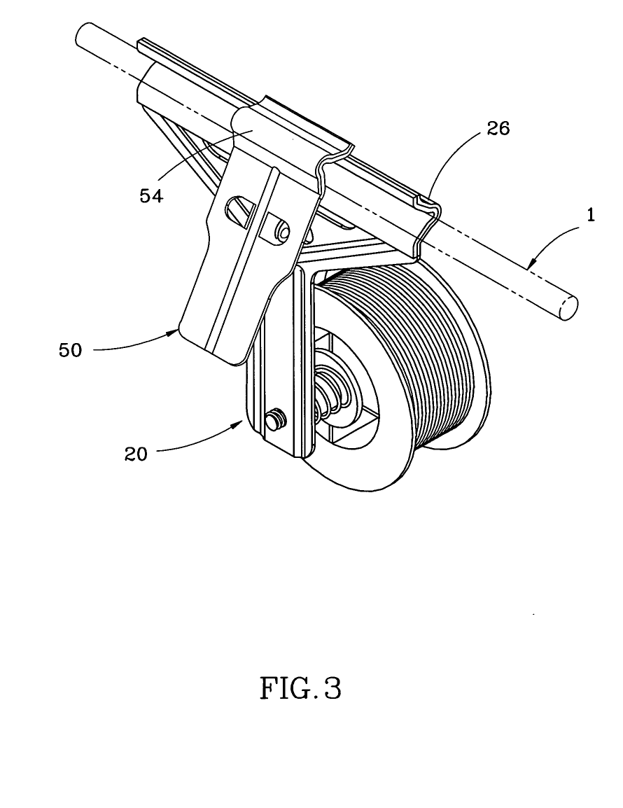

To deserve to be mentioned, the number of the holding portion 26 of the bracket 20 is not limited to two as disclosed in FIGS. 1-2. For example, the bracket 20 can be provided with only one holding portion 26, as shown in FIG. 3.

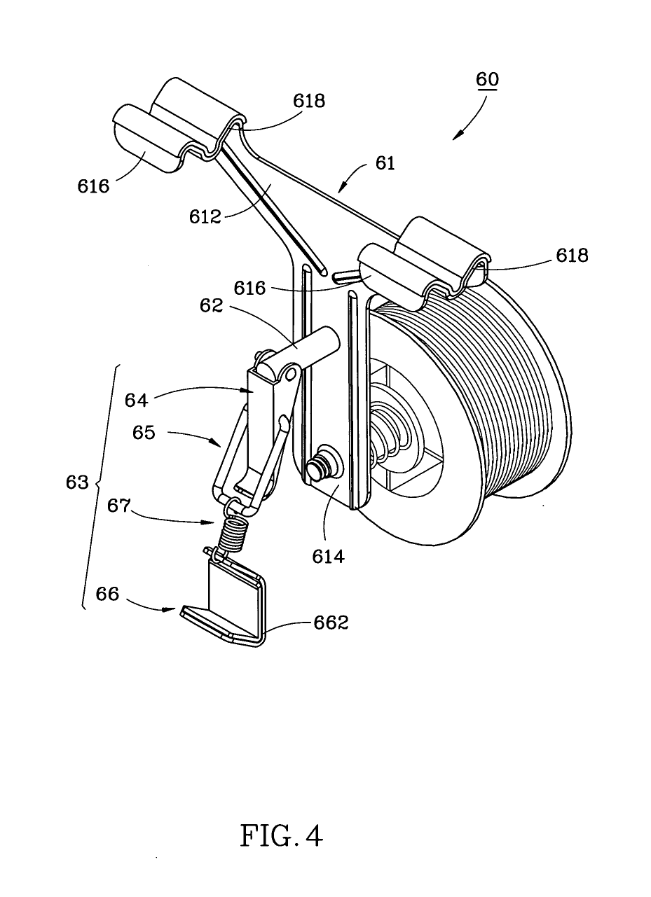

FIG. 4 shows a fishing tackle 60 according to a second preferred embodiment of the present invention. In this embodiment, the bracket 61 has a post 62 extending from the body portion 614, and the holding portions 616 of the bracket 61 extend vertically from the head portion 612. Further, the retainer 63 includes a handle 64 having a top end pivotally connected to the post 62 of the bracket 61, a linking member 65 pivotally connected to a middle of the handle 64, a retaining member 66 defining a retaining portion with a second V-shaped recess 662, and an extension spring 67 having two ends respectively connected to the linking member 65 and the retaining member 66.

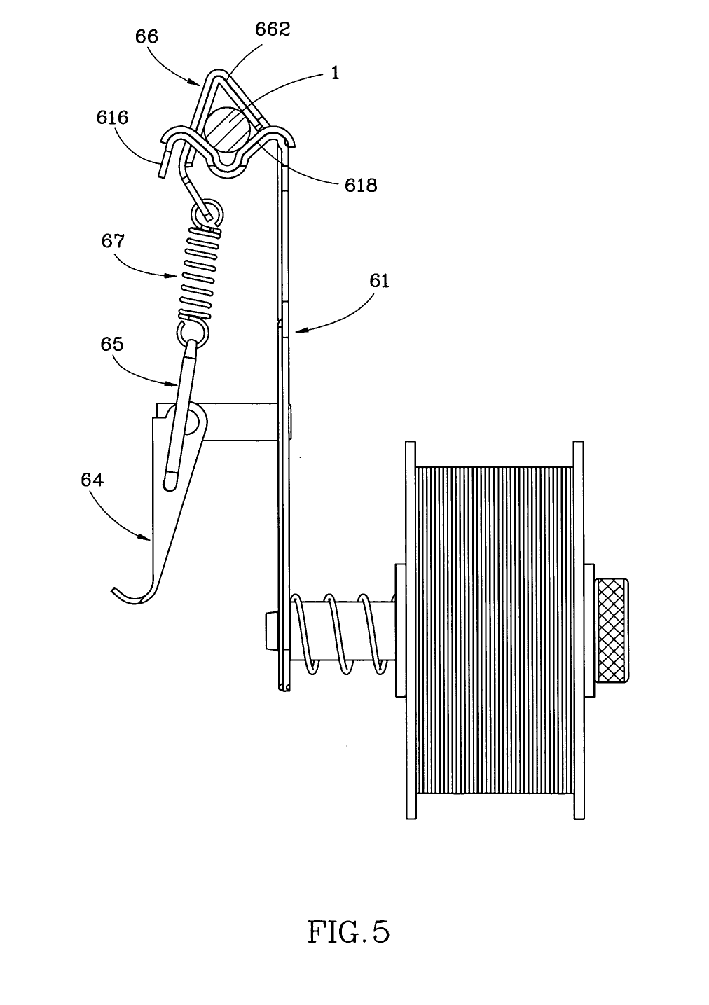

Referring to FIG. 5, when the fishing tackle 60 is mounted with the fishing rod 1, the fishing rod 1 is placed on the first V-shaped recesses 618 of the holding portions 616 of the bracket 61, and then the retaining member 66 is hooked on the fishing rod 1. Thereafter, the angler can press down the handle 64 to stretch the extension spring 67 through the linking member 65, and thus the fishing rod 1 can be clamped between the holding portions 616 of the bracket 61 and the retaining member 66 through the pulling force of the extension spring 67.

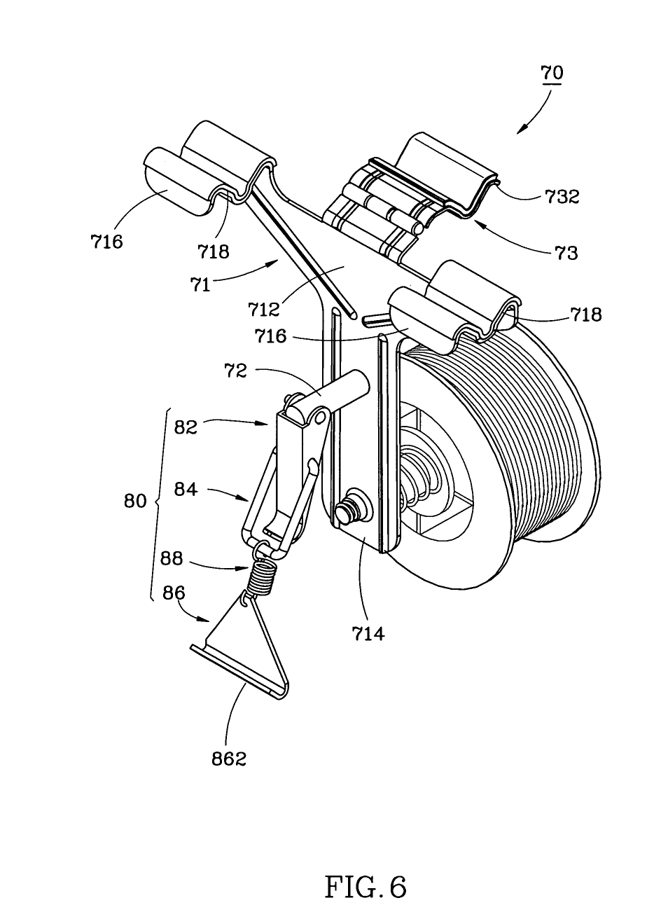

FIG. 6 shows a fishing tackle 70 according to a third preferred embodiment of the present invention. In this embodiment, the holding portions 716 extend vertically from the head portion 712, and the retainer 73 is pivotally connected to a top side of the head portion 712 of the bracket 71. Further, the fishing tackle 70 comprises a retaining unit 80 including a handle 82, a linking member 84, a hook 86, and an extension spring 88.

The handle 82 has a top end pivotally connected to a post 72 extending from the body portion 714 of the bracket 71. The linking member 84 is pivotally connected to a middle of the handle 82. The hook 86 has a first hook portion 862 at a top end thereof. The extension spring 88 has two ends respectively connected to the linking member 84 and the retaining member 86.

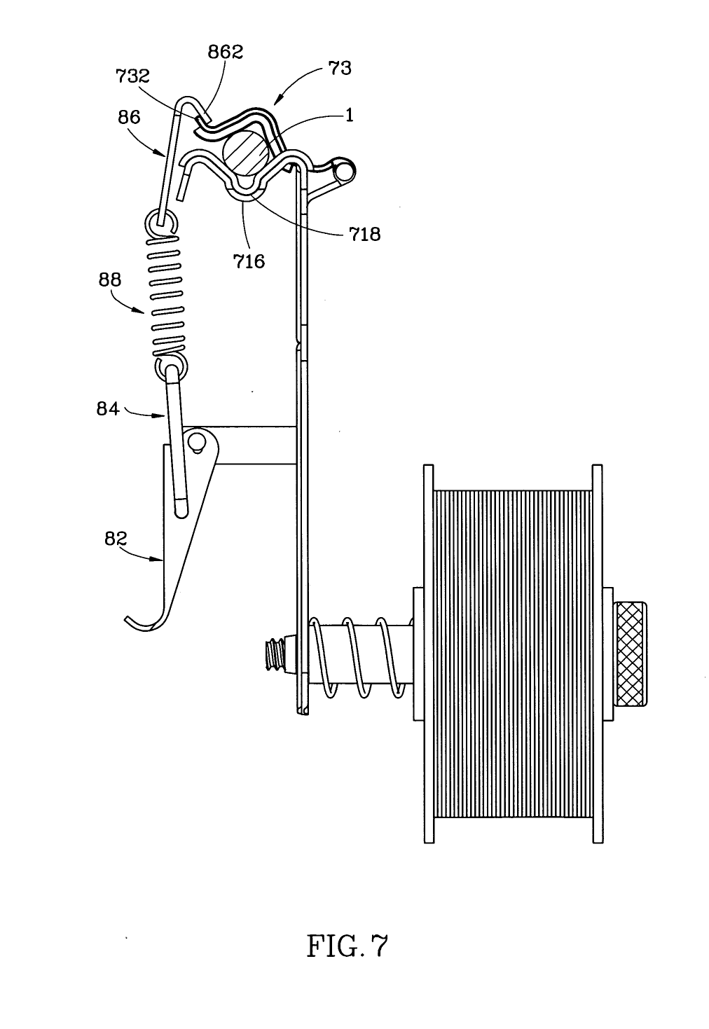

Referring to FIG. 7, when the fishing tackle 70 is mounted with the fishing rod 1, the angler can place the fishing rod 1 on the first V-shaped recess 718 of the holding portions 716 of the bracket 71, and then turn the retainer 73 over the fishing rod 1, and then force the first hook portion 862 of the hook 86 to be hooked to a second hook portion 732 of the retainer 73. Thereafter, the angler can press down the handle 82 to stretch the extension spring 88 through the linking member 88 for allowing the engagement between the first hook portion 862 of the hook 86 and the second hook portion 732 of the retainer 73, thereby securing the fishing tackle 70 to the fishing rod 1.

Accordingly, the fishing tackle of the present invention can be mountable to the fishing rod at any time according the actual needs without any restriction for enhancing the convenience in use and performing a desirable fixed effect.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A fishing tackle for stowage of a fishing line, adapted to be mounted to a fishing rod, the fishing tackle comprising:
a bracket having a holding portion adapted to be abutted against the fishing rod;
a guide rod having a distal end fastened to the bracket;
a spool, around which the fishing line is windable, rotatably mounted to the guide rod; and
a retainer pivotally connected to the bracket and having a retaining portion for pushing the fishing rod to be urged against the holding portion of the bracket such that the fishing tackle can be mounted to the fishing rod by holding the fishing rod between the holding portion of the bracket and the retaining portion of the retainer.

2. The fishing tackle as claimed in claim 1, wherein the fishing rod is adapted to be held between a recess of the holding portion of the retainer and a recess of a retaining portion of the bracket.

3. The fishing tackle as claimed in claim 2, wherein a protective pad is disposed in the recess of the holding portion of the retainer.

4. The fishing tackle as claimed in claim 2, wherein a protective pad is disposed in the second recess of a retaining portion of the bracket.

5. The fishing tackle as claimed in claim 1, wherein the retaining portion of the retainer is integrally formed on a top end of a press portion of the retainer; the press portion of the retainer is pivotally connected to one side of the bracket and urged by a torsion spring such that the retaining portion is forced toward the holding portion of the bracket.

6. The fishing tackle as claimed in claim 5, wherein the holding portion of the bracket extends from a head portion of the bracket; the press portion of the retainer is pivotally connected to the head portion of the bracket; the guide rod is fastened to a body portion of the bracket.

7. The fishing tackle as claimed in claim 1, wherein the retainer comprises a handle pivotally connected to a post of the bracket, a linking member pivotally connected to the handle, a retaining member defining the retaining portion of the retainer, and an extension spring having two ends respectively connected with the linking member and the retaining member.

8. The fishing tackle as claimed in claim 7, wherein the holding portion of the bracket extends vertically from a top side of a head portion of the bracket and the post extends from a body portion of the bracket; the guide rod is fastened to the body portion of the bracket.

9. The fishing tackle as claimed in claim 1, further comprising a retaining unit pivotally connected to the bracket and having a hook engagable with the retainer pivotally connected to a top side of the bracket such that the retainer can be forced by the hook to press against the fishing rod.

10. The fishing tackle as claimed in claim 9, wherein the retaining unit comprises a handle pivotally connected to a post of the bracket, a linking member pivotally connected to the handle, and an extension spring having two ends respectively connected to the linking member and the hook.

11. The fishing tackle as claimed in claim 10, wherein the holding portion of the bracket extends vertically from a top side of a head portion of the bracket; the retainer is pivotally connected to the top side of the head portion of the bracket; the post of the bracket extends from a body portion of the bracket; the guide rod is fastened to the body portion of the bracket.

12. The fishing tackle as claimed in claim 1, further comprising a spring member sleeved on the guide rod and stopped against the spool for enabling the spool to be movable along an axial direction of the guide rod.

13. The fishing tackle as claimed in claim 1, wherein the bracket comprises two said holding portions spaced from each other, and the retaining portion is located between the holding portions.
